(19) United States
(12) Patent Application Publication
(10) Pub. No.: US 2016/0105941 A1
(43) Pub. Date: Apr. 14, 2016

(54) LOAD DRIVING APPARATUS WITH WIDE VOLTAGE INPUT

(71) Applicant: Beyond Innovation Technology Co., Ltd., Taipei City (TW)

(72) Inventors: Zhen-Chun Liu, Taipei City (TW); Chen-Lung Kao, Taipei City (TW)

(21) Appl. No.: 14/809,267

(22) Filed: Jul. 26, 2015

(30) Foreign Application Priority Data
Oct. 13, 2014 (TW) 103135358

(51) Int. Cl. H05B 37/02

(52) U.S. Cl. CPC H05B 37/02

(57) ABSTRACT

A load driving apparatus is provided, which includes: a DC high voltage generation circuit, configured to selectively receive one of first and second AC input voltages different to each other, and process the received AC input voltage to obtain and provide a DC high voltage, wherein the DC high voltage obtained by processing either the first or second AC input voltages is substantially or approximately the same; a switching circuit, configured to selectively output the DC high voltage or a ground potential in response to two complementary PWM signals, so as to provide an AC signal; a transformer, having a primary side receiving the AC signal from the switching circuit, and a secondary side providing a driving signal to drive a light-emitting load in response to the AC signal; and a control circuit, configured to generate the two complementary PWM signals to control switching of the switching circuit.

### CROSS-REFERENCE TO RELATED APPLICATION

This application claims the priority benefit of Taiwan application serial no. 103135358, filed on Oct. 13, 2014. The entirety of the above-mentioned patent application is hereby incorporated by reference herein and made a part of this specification.

### BACKGROUND OF THE INVENTION

1. Field of the Invention

The invention relates to a load driving technique, and particularly relates to a load driving apparatus with wide voltage input constructed under a single specification transformer.

2. Description of Related Art

Generally, a load driving apparatus/system of 110ACV (an alternating current voltage) and a load driving apparatus/system of 220ACV (an alternating current voltage) have to respectively use transformers of different specifications (for example, transformers with different turns ratios). Therefore, the transformers respectively in the load driving apparatus/system of 110ACV and the load driving apparatus/system of 220ACV have to be separately purchased (i.e. two different materials are required to be purchased), by which not only a purchase cost is increased, it may also cause inconvenience in material inventory management.

### SUMMARY OF THE INVENTION

Accordingly, the invention is directed to a load driving apparatus with wide voltage input constructed under a single specification transformer, so as to effectively resolve the problem mentioned in the related art.

Other objects and advantages of the invention can be further illustrated by the technical features broadly embodied and described as follows.

An exemplary embodiment of the invention provides a load driving apparatus with wide voltage input constructed under a single specification transformer, which includes a direct current (DC) high voltage generation circuit, a switching circuit, a transformer and a control circuit. The DC high voltage generation circuit is configured to selectively receive one of a first alternating current (AC) input voltage and a second AC input voltage different to each other, and processes the received AC input voltage to obtain and provide a DC high voltage, wherein the DC high voltage obtained by processing the first AC input voltage is substantially or approximately the same to the DC high voltage obtained by processing the second AC input voltage. The switching circuit is coupled between the DC high voltage and a ground potential, and is configured to selectively output the DC high voltage or the ground potential in response to two complementary pulse width modulation (PWM) signals, so as to provide an AC signal. The transformer has a primary side and a secondary side, wherein the primary side of the transformer is coupled to the switching circuit to receive the AC signal, and the secondary side of the transformer provides a driving signal to drive a light-emitting load in response to the AC signal received by the primary side. The control circuit is operated under a system voltage and is coupled to the switching circuit, and is configured to generate the two complementary PWM signals to control switching/operation of the switching circuit.

In an exemplary embodiment of the invention, the first AC input voltage is a 220V AC input voltage, and the second AC input voltage is a 110V AC input voltage. In this way, the DC high voltage generation circuit includes a bridge rectifier, a toggle switch, a first diode, a voltage doubler unit and a power filter unit. An input side of the bridge rectifier is configured to selectively receive one of the first AC input voltage and the second AC input voltage, and an output side of the bridge rectifier provides a rectified voltage. The toggle switch is coupled to the output side of the bridge rectifier, and transmits the rectified voltage to a first node corresponding to the 220V AC input voltage or a second node corresponding to the 110V AC input voltage according to the AC input voltage received by the bridge rectifier. The first diode is coupled to the first node, and is configured to receive and transmit the rectified voltage corresponding to the 220V AC input voltage. The voltage doubler unit is coupled to the second node, and is configured to receive the rectified voltage corresponding to the 110V AC input voltage and perform a voltage doubling processing on the rectified voltage for outputting. The power filter unit is coupled to a cathode of the first diode and an output of the voltage doubler unit, and provides the DC high voltage in response to the rectified voltage transmitted by the first diode or the output of the voltage doubler unit.

In an exemplary embodiment of the invention, the load driving apparatus further includes a valley fill circuit, which is coupled between the DC high voltage and the ground potential, and is configured to increase an input power factor of the load driving apparatus.

In an exemplary embodiment of the invention, the voltage doubler unit in the DC high voltage generation circuit is further coupled to the switching circuit to compensate or again increase the input power factor of the load driving apparatus.

According to the above descriptions, the load driving apparatus of the invention can be constructed under a single specification transformer (for example, a transformer adopting the 220ACV) to achieve a characteristic of wide voltage input (for example, 110ACV or 220ACV) based on the voltage doubler unit configured in the DC high voltage generation circuit, so as to drive a light-emitting load. In this way, the load driving apparatus of the invention can be taken as both of a load driving apparatus/system of 110ACV and a load driving apparatus/system of 220ACV, so as to facilitate mass production of the product. On the other hand, since only the transformers with a same specification (220ACV) are required to be purchased, the material inventory management is simplified, and the cost used for purchasing the transformers is reduced.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system structural diagram of a load driving apparatus according to an exemplary embodiment of the invention.

FIG. 2 is a block diagram of the load driving apparatus of FIG. 1.

FIG. 3 is a circuit diagram of the load driving apparatus of FIG. 2.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

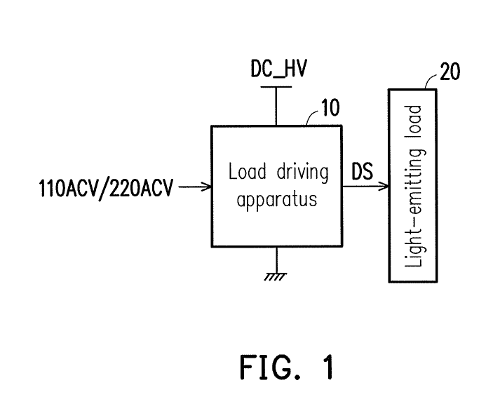

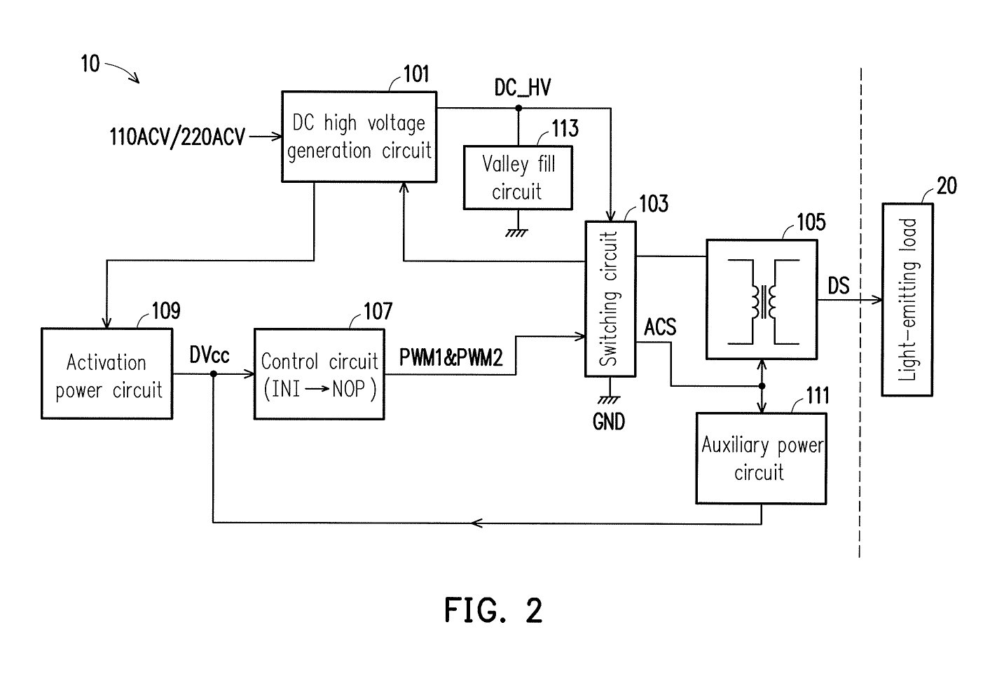

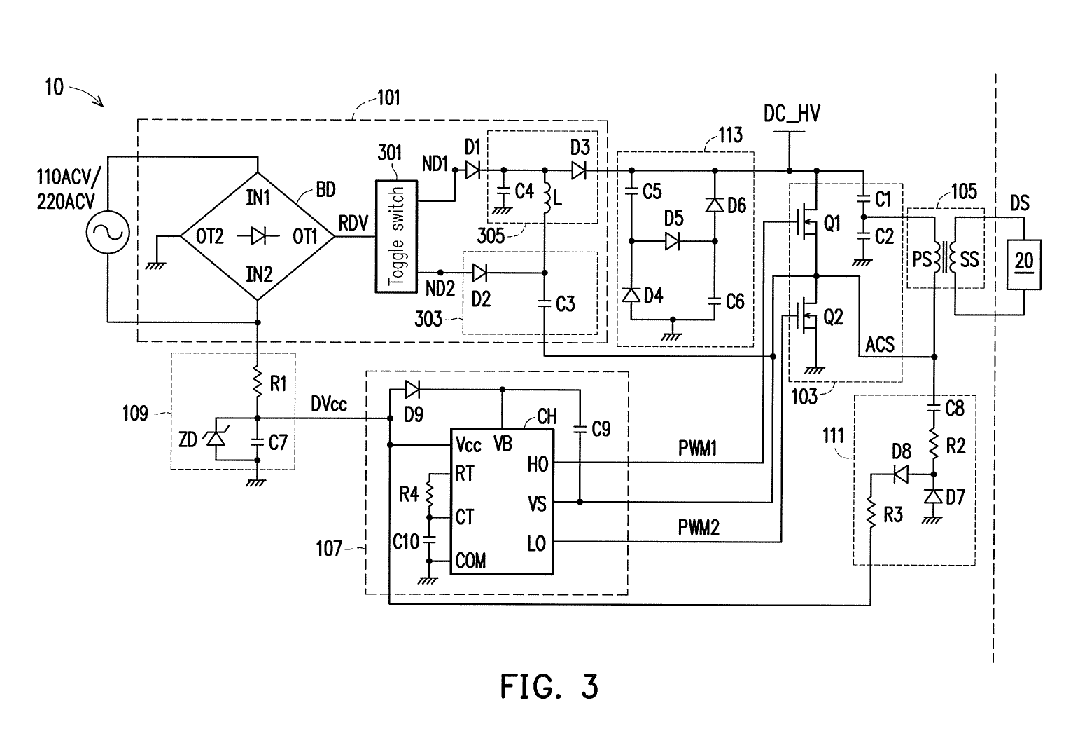

FIG. 1 is a system structural diagram of a load driving apparatus 10 according to an exemplary embodiment of the invention. FIG. 2 is a block diagram of the load driving apparatus 10 of FIG. 1. FIG. 3 is a circuit diagram of the load driving apparatus 10 of FIG. 2. Referring to FIG. 1-FIG. 3, the load driving apparatus 10 is adapted to provide a driving signal DS to drive a light-emitting load 20 of any type, for example, any resistive or capacitive light-emitting load (which can be but not limited to an alternating current (AC) light-emitting diode (LED) load or a lamp load). The load driving apparatus 10 may include a direct current (DC) high voltage generation circuit 101, a switching circuit 103, a transformer 105, a control circuit 107, an activation power circuit 109, an auxiliary power circuit 111 and a valley fill circuit 113.

The DC high voltage generation circuit 101 is configured to selectively receive one of a first AC input voltage (for example, a 220V AC input voltage) 220ACV and a second AC input voltage (for example, a 110V AC input voltage) 110ACV different to each other, and processes the received AC input voltage 220ACV/110ACV to obtain and provide a DC high voltage DC_HV.

The switching circuit 101 is coupled between the DC high voltage DC_HV and a ground potential GND, and is configured to selectively output the DC high voltage DC_HV or the ground potential GND in response to two complementary pulse width modulation (PWM) signals (for example, a first PWM signal PWM1 and a second PWM signal PWM2, so as to provide an AC signal ACS.

The transformer 105 has a primary side PS and a secondary side SS, where the primary side PS of the transformer 105 is coupled to the switching circuit 103 to receive the AC signal ACS, and the secondary side SS of the transformer 105 provides the driving signal DS to drive the light-emitting load 20 in response to the AC signal ACS received by the primary side PS. In the present exemplary embodiment, the transformer 105 is a transformer adopting the 220 ACV.

The control circuit 107 serves as an operation core of the load driving apparatus 10, and is operated under a system voltage DVcc and is coupled to the switching circuit 103. The control circuit 107 is configured to generate the two complementary PWM signals (PWM1 and PWM2) to control switching/operation of the switching circuit 103.

The activation power circuit 109 is coupled to the DC high voltage generation circuit 101 and the control circuit 107, and is configured to generate the system voltage DVcc required by the control circuit 107 during an initial operation phase INI of the load driving apparatus 10, so as to activate the control circuit 107.

The auxiliary power circuit 111 is coupled to the switching circuit 103, the transformer 105 and the control circuit 107, and is configured to replace the activation power circuit 109 to generate the system voltage DVcc required by the control circuit 107 when the load driving apparatus 10 enters a normal operation phase NOP from the initial operation phase INI.

The valley fill circuit 113 is also coupled between the DC high voltage DC_HV and the ground potential GND, and is configured to increase an input power factor (input PF) of the load driving apparatus 10, such that the load driving apparatus 10 can be complied with respective PF specifications of a residential lighting driver and a commercial lighting driver (note: the PF specification of the residential lighting driver has to be greater than 0.7, and the PF specification of the commercial lighting driver has to be greater than 0.9).

In the present exemplary embodiment, the DC high voltage DC_HV obtained by the DC high voltage generation circuit 101 by processing the first AC input voltage 220ACV is substantially or approximately the same to the DC high voltage DC_HV obtained by the DC high voltage generation circuit 101 by processing the second AC input voltage 110ACV. In other words, the DC high voltages DC_HV obtained by the DC high voltage generation circuit 101 by processing the first and the second AC input voltage 220ACV, 110ACV are substantially or approximately the same. Under such condition, respective input powers (I/Ps) of the first AC input voltage 220ACV and the second AC input voltage 110ACV are approximately the same, so that the load driving apparatus 10 can be constructed under the single specification transformer 105 (for example, the transformer adopting the 220ACV) to achieve a characteristic of wide voltage input (for example, 110ACV or 220ACV), so as to drive the light-emitting load 20.

As shown in FIG. 3, the switching circuit 103 may include (N-type) power switches (Q1, Q2) and capacitors (C1, C2). A drain of the power switch Q1 is coupled to the DC high voltage DC_HV, a source of the power switch Q1 is coupled to a first end of the primary side PS of the transformer 105, and is configured to provide the AC signal ACS, and a gate of the power switch Q1 is configured to receive the PWM signal PWM1 from the control circuit 107. A drain of the power switch Q2 is coupled to the source of the power switch Q1, a gate of the power switch Q2 is configured to receive the PWM signal PWM2 from the control circuit 107, and a source of the power switch Q2 is coupled to the ground potential GND. A first end of the capacitor C1 is coupled to the drain of the power switch Q1, and a second end of the capacitor C1 is coupled to a second end of the primary side PS of the transformer 105. A first end of the capacitor C2 is coupled to the second end of the capacitor C1, and a second end of the capacitor C2 is coupled to the ground potential GND.

The DC high voltage generating circuit 101 may include a bridge rectifier BD, a toggle switch 301, a diode D1, a voltage doubler unit 303 and a power filter unit 305. An input side (IN1, IN2) of the bridge rectifier BD is configured to selectively receive one of the first AC input voltage 220ACV and the second AC input voltage 110ACV, and an output side (OT1, OT2) of the bridge rectifier BD provides a rectified voltage RDV. In the present exemplary embodiment, the bridge rectifier BD can be implemented by a full-bridge rectifier, though the invention is not limited thereto.

The toggle switch 301 is coupled to one end (OT1) of the output side (OT1, OT2) of the bridge rectifier BD, and transmits the rectified voltage RDV to a first node ND1 corresponding to the 220V AC input voltage (220ACV) or a second node ND2 corresponding to the 110V AC input voltage (110ACV) according to the AC input voltage 220ACV/110ACV received by the bridge rectifier BD. To be specific, the toggle switch 301 can be implemented by any active or passive switch module, and when the AC input voltage received by the bridge rectifier BD is the 220V AC input voltage (220ACV), the toggle switch 301 transmits the rectified voltage RDV to the first node ND1, and the diode D1 coupled to the first node ND1 receives and transmits the rectified voltage RDV corresponding to the 220V AC input voltage (220ACV). Meanwhile, the voltage doubler unit 303 is in an off state.

Conversely, when the AC input voltage received by the bridge rectifier BD is the 110V AC input voltage (110ACV), the toggle switch 301 transmits the rectified voltage RDV to the second node ND2, such that the voltage doubler unit 303 coupled to the second node ND2 is activated, and receives the rectified voltage RDV corresponding to the 110V AC input voltage (110ACV) and performs voltage doubling processing to the same for outputting. In this way, though the voltage doubling processing of the voltage doubler unit 303, the respective input powers of the first AC input voltage 220ACV and the second AC input voltage 110ACV are approximately the same. In the present exemplary embodiment, the voltage doubler unit 330 may include a diode D2 and a capacitor C3. An anode of the diode D2 is coupled to the second node ND2, a first end of the capacitor C3 is coupled to a cathode (serving as an output of the voltage doubler unit 303) of the diode D2, and a second end of the capacitor C3 is coupled to the source of the power switch Q1 and the drain of the power switch Q2.

The power filter unit 305 is coupled to a cathode of the diode D1 and the output of the voltage doubler unit 303, and provides the DC high voltage DC_HV in response to the rectified voltage RDV transmitted by the diode D1 or the output of the voltage doubler unit 303. In the present exemplary embodiment, the power filter unit 305 may include a (filter) capacitor C4, a (filter) inductor L and an (isolation) diode D3. A first end of the capacitor C4 is coupled to the cathode of the diode D1, and a second end of the capacitor C4 is coupled to the ground potential GND. A first end of the inductor L is coupled to the cathode of the diode D1, and a second end of the inductor L is coupled to the cathode of the diode D2. An anode of the diode D3 is coupled to the first end of the inductor L, and a cathode of the diode D3 provides the DC high voltage DC_HV.

The valley fill circuit 113 may include capacitors (C5, C6) and diodes (D4, D5, D6). A first end of the capacitor C5 is coupled to the DC high voltage DC_HV. A cathode of the diode D4 is coupled to a second end of the capacitor C5, and an anode of the diode D4 is coupled to the ground potential GND. An anode of the diode D5 is coupled to the cathode of the diode D4. A cathode of the diode D6 is coupled to the DC high voltage DC_HV, and an anode of the diode D6 is coupled to a cathode of the diode D5. A first end of the capacitor C6 is coupled to the anode of the diode D6, and a second end of the capacitor C6 is coupled to the ground potential GND.

In the present exemplary embodiment, a conduction time of the bridge rectifier BD can be changed based on different charging path(s) and discharging path(s) of the capacitors (C5 and C6) of the valley fill circuit 113. The bridge rectifier BD is not conducted when the received AC input voltage (110ACV/220ACV) is smaller than a half of a peak value thereof, and the bridge rectifier BD is in a conduction state as long as the received AC input voltage (110ACV/220ACV) is greater than a half of the peak value thereof. Once the conduction time of the bridge rectifier BD is prolonged, the input PF of the load driving apparatus 10 is enhanced to at least 0.8-0.9. Even more, as an effect voltage and current phase adjustment is achieved by coupling the voltage doubler unit 303 to the switching circuit 103 through the capacitor C3, the input PF of the load driving apparatus 10 is compensated or further enhanced to be more than 0.9.

The activation power circuit 109 may include at least one resistor R1, at least one capacitor C7 and a Zener diode ZD. A first end of the resistor R1 is coupled to one end (IN2) of the input side (IN1, IN2) of the bridge rectifier BD, and a second end of the resistor R1 provides the system voltage DVcc required by the control circuit 107. A first end of the capacitor C7 is coupled to the second end of the resistor R1, and a second end of the capacitor C7 is coupled to the ground potential GND. A cathode of the Zener diode ZD is coupled to the first end of the capacitor C7, and an anode of the Zener diode ZD is coupled to the ground potential GND. In the present exemplary embodiment, the resistor R1 can be implemented by a single resistor or a plurality of resistors connected in series, which is determined according to an actual design or application requirement. Similarly, the capacitor C7 can be implemented by one capacitor or a plurality of capacitors connected in parallel, which is determined according to an actual design or application requirement.

The auxiliary power circuit 111 may include a capacitor C8, resistors (R2, R3), and diodes (D7, D8). A first end of the capacitor C8 is coupled to the first end of the primary side PS of the transformer 105, and a first end of the resistor R2 is coupled to a second end of the capacitor C8. A cathode of the diode D7 is coupled to a second end of the resistor R2, and an anode of the diode D7 is coupled to the ground potential GND. An anode of the diode D8 is coupled to cathode of the diode D7, a first end of the resistor R3 is coupled to a cathode of the diode D8, and a second end of the resistor R3 provides the system voltage DVcc required by the control circuit 107.

The control circuit 107 may include a control chip CH, a diode D9, capacitors (C9, C10) and a resistor R4. The control chip CH can be implemented by a chip with a referential number of IC2153, though the invention is not limited thereto, and any chip having a similar function can be adopted according to an actual design or application requirement. Under such condition, the control chip CH may have a VCC pin, a COM pin, a RT pin, a CT pin, a VB pin, a VS pin, an HO pin and an LO pin. The control chip CH respectively outputs the PWM signals (PWM1, PWM2) through the HO pin and the LO pin, and the control chip CH receives the system voltage DVcc through the Vcc pin. An anode of the diode D9 is coupled to the Vcc pin of the control chip CH, and a cathode of the diode D9 is coupled to the VB pin of the control chip CH.

A first end of the capacitor C9 is coupled to the VB pin of the control chip, and a second end of the capacitor C9 is coupled to the VS pin of the control chip CH and the source of the power switch Q1 and the drain of the power switch Q2. A first end of the resistor R4 is coupled to the RT pin of the control chip CH, and a second end of the resistor R4 is coupled to the CT pin of the control chip CH. A first end of the capacitor C10 is coupled to the CT pin of the control chip CH, and a second end of the capacitor C10 is coupled to the COM pin of the control chip CH and the ground potential GND.

In summary, the load driving apparatus 10 of the invention can be constructed under the single specification transformer 105 (for example, a transformer adopting the 220ACV) to achieve a characteristic of wide voltage input (for example, 110ACV or 220ACV) based on the voltage doubler unit 303 configured in the DC high voltage generation circuit 101, so as to drive the light-emitting load 20. In this way, the load driving apparatus 10 of the invention can be taken as both of a load driving apparatus/system of 110ACV and a load driving apparatus/system of 220ACV, so as to facilitate mass production of the product. On the other hand, since only the transformers 105 with a same specification (220ACV) are required to be purchased, the material inventory management is simplified, and the cost used for purchasing the transformers is reduced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

Moreover, any embodiment of or the claims of the invention is unnecessary to implement all advantages or features disclosed by the invention. Moreover, the abstract and the name of the invention are only used to assist patent searching, and are not used for limiting the invention.

What is claimed is:

1. A load driving apparatus, comprising:
a direct current high voltage generation circuit, configured to selectively receive one of a first alternating current input voltage and a second alternating current input voltage different to each other, and processing the received alternating current input voltage to obtain and provide a direct current high voltage, wherein the direct current high voltage obtained by processing the first alternating current input voltage is substantially or approximately the same to the direct current high voltage obtained by processing the second alternating current input voltage;
a switching circuit, coupled between the direct current high voltage and a ground potential, and configured to selectively output the direct current high voltage or the ground potential in response to two complementary pulse width modulation signals, so as to provide an alternating current signal;
a transformer, having a primary side and a secondary side, wherein the primary side is coupled to the switching circuit to receive the alternating current signal, and the secondary side provides a driving signal to drive a light-emitting load in response to the alternating current signal received by the primary side; and
a control circuit, operated under a system voltage and coupled to the switching circuit, and configured to generate the two complementary pulse width modulation signals to control switching of the switching circuit.

2. The load driving apparatus as claimed in claim 1, wherein the first alternating current input voltage is a 220V alternating current input voltage, and the second alternating current input voltage is a 110V alternating current input voltage, and the direct current high voltage generation circuit comprises:
a bridge rectifier, having an input side selectively receiving one of the first alternating current input voltage and the second alternating current input voltage, and an output side providing a rectified voltage;
a toggle switch, coupled to the output side of the bridge rectifier, and transmitting the rectified voltage to a first node corresponding to the 220V alternating current input voltage or a second node corresponding to the 110V alternating current input voltage according to the alternating current input voltage received by the bridge rectifier;
a first diode, coupled to the first node, and configured to receive and transmit the rectified voltage corresponding to the 220V alternating current input voltage;
a voltage doubler unit, coupled to the second node, and configured to receive the rectified voltage corresponding to the 110V alternating current input voltage and perform a voltage doubling processing on the rectified voltage for outputting; and
a power filter unit, coupled to a cathode of the first diode and an output of the voltage doubler unit, and providing the direct current high voltage in response to the rectified voltage transmitted by the first diode or the output of the voltage doubler unit.

3. The load driving apparatus as claimed in claim 2, wherein:
when the alternating current input voltage received by the bridge rectifier is the 220V alternating current input voltage, the toggle switch transmits the rectified voltage to the first node; and
when the alternating current input voltage received by the bridge rectifier is the 110V alternating current input voltage, the toggle switch transmits the rectified voltage to the second node.

4. The load driving apparatus as claimed in claim 2, wherein the two complementary pulse width modulation signals comprise a first pulse width modulation signal and a second pulse width modulation signal, and the switching circuit comprises:
a first power switch, having a drain coupled to the direct current high voltage, a source coupled to a first end of the primary side for providing the alternating current signal, and a gate configured to receive the first pulse width modulation signal;
a second power switch, having a drain coupled to the source of the first power switch, a gate configured to receive the second pulse width modulation signal, and a source coupled to the ground potential;
a first capacitor, having a first end coupled to the drain of the first power switch, and a second end coupled to a second end of the primary side; and
a second capacitor, having a first end coupled to the second end of the first capacitor, and a second end coupled to the ground potential.

5. The load driving apparatus as claimed in claim 4, further comprising:
a valley fill circuit, coupled between the direct current high voltage and the ground potential, and configured to increase an input power factor of the load driving apparatus.

6. The load driving apparatus as claimed in claim 5, wherein the voltage doubler unit is further coupled to the switching circuit to compensate the input power factor of the load driving apparatus, and the voltage doubler unit comprises:
a second diode, having an anode coupled to the second node; and
a third capacitor, having a first end coupled to a cathode of the second diode, and a second end coupled to the source of the first power switch and the drain of the second power switch.

7. The load driving apparatus as claimed in claim 6, wherein the power filter unit comprises:
a fourth capacitor, having a first end coupled to the cathode of the first diode, and a second end coupled to the ground potential;
an inductor, having a first end coupled to the cathode of the first diode, and a second end coupled to the cathode of the second diode; and
a third diode, having an anode coupled to the first end of the inductor, and a cathode providing the direct current high voltage.

8. The load driving apparatus as claimed in claim 5, wherein the valley fill circuit comprises:
a third capacitor, having a first end coupled to the direct current high voltage;
a second diode, having a cathode coupled to a second end of the third capacitor, and an anode coupled to the ground potential;
a third diode, having an anode coupled to the cathode of the second diode;
a fourth diode, having a cathode coupled to the direct current high voltage, and an anode coupled to a cathode of the third diode; and
a fourth capacitor, having a first end coupled to the anode of the fourth diode, and a second end coupled to the ground potential.

9. The load driving apparatus as claimed in claim 4, further comprising:
an activation power circuit, coupled to one end of the input side of the bridge rectifier and the control circuit, and configured to generate the system voltage required by the control circuit during an initial operation phase of the load driving apparatus, so as to activate the control circuit.

10. The load driving apparatus as claimed in claim 9, wherein the activation power circuit comprises:
at least one resistor, having a first end coupled to one end of the input side of the bridge rectifier, and a second end providing the system voltage required by the control circuit;
at least one capacitor, having a first end coupled to the second end of the at least one resistor, and a second end coupled to the ground potential; and
a Zener diode, having a cathode coupled to the first end of the at least one capacitor, and an anode coupled to the ground potential.

11. The load driving apparatus as claimed in claim 9, further comprising:
an auxiliary power circuit, coupled to the switching circuit, the transformer and the control circuit, and configured to replace the activation power circuit to generate the system voltage required by the control circuit when the load driving apparatus enters a normal operation phase from the initial operation phase.

12. The load driving apparatus as claimed in claim 11, wherein the auxiliary power circuit comprises:
a third capacitor, having a first end coupled to the first end of the primary side;
a first resistor, having a first end coupled to a second end of the third capacitor;
a second diode, having a cathode coupled to a second end of the first resistor, and an anode coupled to the ground potential;
a third diode, having an anode coupled to the cathode of the second diode; and
a second resistor, having a first end coupled to a cathode of the third diode, and a second end providing the system voltage required by the control circuit.

13. The load driving apparatus as claimed in claim 4, wherein the control circuit comprises:
a control chip, having a Vcc pin, a COM pin, a RT pin, a CT pin, a VB pin, a VS pin, an HO pin and an LO pin, wherein the control chip respectively outputs the first pulse width modulation signal and the second pulse width modulation signal through the HO pin and the LO pin, and the control chip receives the system voltage through the Vcc pin;
a second diode, having an anode coupled to the Vcc pin, and a cathode coupled to the VB pin;
a third capacitor, having a first end coupled to the VB pin, and a second end coupled to the VS pin and the source of the first power switch and the drain of the second power switch;
a resistor, having a first end coupled to the RT pin, and a second end coupled to the CT pin; and
a fourth capacitor, having a first end coupled to the CT pin, and a second end coupled to the COM pin and the ground potential.
